(19) United States
(12) Patent Application Publication
(10) Pub. No.: US 2006/0282303 A1
(43) Pub. Date: Dec. 14, 2006

(54) Distributed organizational analyzer

(75) Inventors: Leland E. Hale, Port Orchard, WA (US); Sunil Swami, Sammamish, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/149,108

(22) Filed: Jun. 8, 2005

(51) Int. Cl. G06F 17/30

(52) U.S. Cl. 705/10

(57) ABSTRACT

A distributed organizational analyzer configured to determine characteristics of an organization based on tasks performed by both clients and servers is provided. The characteristics determined by the distributed organizational analyzer may include relationship trends, emerging topics and other organizational intelligence related information. The clients are configured to generate profiles for users associated with the organization. Each profile is generated from client data, such as emails, messages, local documents, newsgroup and weblog data, or the like. The server aggregates the profiles to identify interaction patterns and keywords that are popular in the organization. The server then analyzes the interaction patterns and popular keywords to determine relationship trends between users and groups in the organization, and emerging topics that are important to the organization. Since the clients are performing the data mining and profile generation tasks, client data that is restricted may be accounted by the analysis without sacrificing privacy and security. Also, by mining and aggregating the near-real-time interactions between users, the distributed organizational analyzer may provide a responsive feedback mechanism that can more quickly and accurately provide organizational intelligence.

### BACKGROUND

Business intelligence has traditionally relied on structured, database-organized information to generate insight into group dynamics, collaboration opportunities, business trends and emerging issues. However, this approach is limited because a significant amount of information within organizations is stored outside traditional databases in the client data, such as emails, websites, weblogs, and local documents.

While some emerging business intelligence systems have started to take replicated client data into account, these systems typically use a top-down approach that mines data repositories on servers in much the same fashion as their traditional counterparts. The problem with this approach is that both email and local documents may be only partially mined, due to access restrictions placed on those resources. Consequently, significant portions of business intelligence are unavailable using these methods.

An effective solution for gathering business intelligence that is not unnecessarily hindered by organizational issues continues to elude those skilled in the art.

### DESCRIPTION OF THE DRAWINGS

The present description will be better understood from the following detailed description read in light of the accompanying drawings, wherein:

FIG. 1 shows an example system for distributed organizational analysis.

FIG. 2 shows example components of the client analytic module and the server analytic module illustrated in FIG. 1.

FIG. 3 shows a screenshot of an example user interface for a distributed organizational analyzer.

FIG. 4 shows an example process for providing a profile associated with a user.

FIG. 5 shows an example process for determining characteristics of an organization from profiles.

FIG. 6 shows an example computer device for implementing the described systems and methods.

Like reference numerals are used to designate like parts in the accompanying drawings.

### DETAILED DESCRIPTION

The described systems and methods are directed to a distributed organizational analyzer configured to determine characteristics of an organization based on tasks performed by both clients and servers. The characteristics determined by the distributed organizational analyzer may include relationship trends, emerging topics and other organizational intelligence related information. The clients are configured to generate profiles for users associated with the organization. Each profile is generated from client data, such as emails, messages, local documents, newsgroup and weblog data, or the like. The server aggregates the profiles to identify interaction patterns and keywords that are popular in the organization. The server then analyzes the interaction patterns and popular keywords to determine relationship trends between users and groups in the organization, and emerging topics that are important to the organization. Since the clients are performing the data mining and profile generation tasks, client data that is restricted may be accounted by the analysis without sacrificing privacy and security. Also, by mining and aggregating the near-real-time interactions between users, the distributed organizational analyzer may provide a responsive feedback mechanism that can more quickly and accurately provide organizational intelligence.

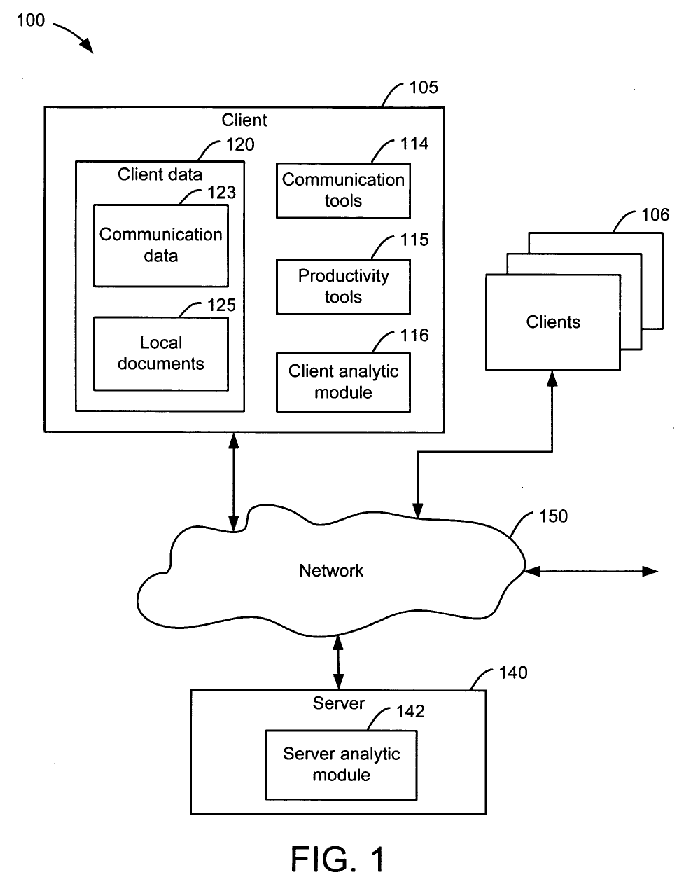

FIG. 1 shows an example system 100 for distributed organizational analysis. As shown in FIG. 1, system 100 includes clients 105-106 that are configured to communicate with server 140 through network 150. Typically, clients 105-106 are computing devices that are associated with an organization, such as a business, a government agency, a group of users, or the like. Each of the clients 105-106 may be used by one or more users belonging to the organization. Each of the clients 105-106 may include various components. For ease of illustration, only example components for client 105 are shown in FIG. 1.

Client 105 may include communication tools 114 and productivity tools 115, which are configured to generate client data 120. Communication tools 114 may include any device-executable component used by a user to communicate with others. For example, communication tools 114 may include an email application, messenger, web browser, file-sharing application, message management tools, such as those for newsgroup and weblogs, or the like. Communication tools 114 may be configured to generate communication data 123 such as emails, messages, online chat dialog, webpages, weblog and newsgroup data, or the like.

Productivity tools 115 may include any device-executable component used by a user to perform tasks. For example, productivity tools 115 may include a word processing application, spreadsheet, presentation tool, database, project management tool, note management application, media application, web authoring tool, or the like. Productivity tools may be configured to generate and manage local documents 125, which include document files that are stored locally in client 105.

For security reasons, access to client data 120 may be restricted. For example, some client data 120 may be available only to certain users. Other client data 120 may only be available on a read-only basis or may not be network accessible. Client data 120 may or may not persist on client 105 after being generated. For example, communication tools 114 may be configured to send certain client data 120, such as an email or an instant messenger (IM) message, to another device, without persisting the data on client 105.

Client analytic module 116 is configured to monitor client data 120 and to generate a profile associated with a user associated client 105. A profile may include any type of information about the user, such as other users to which the user interacts and the topics of the user's communications. Client analytic module 116 is configured to provide one or more profiles to server analytic module 142 for processing. Client analytic module 116 may be configured to create the profiles from client data 120 persisted on client 105. For example, the profiles may be periodically created from client data that is stored on client 105. The client analytic module 116 may also be configured to dynamically generate the profiles. For example, client analytic module 116 may be configured to receive client data as it is generated by communication tools 114 and productivity tools 115. In this manner, client analytic module 116 may create dynamic profiles that are updated in real-time.

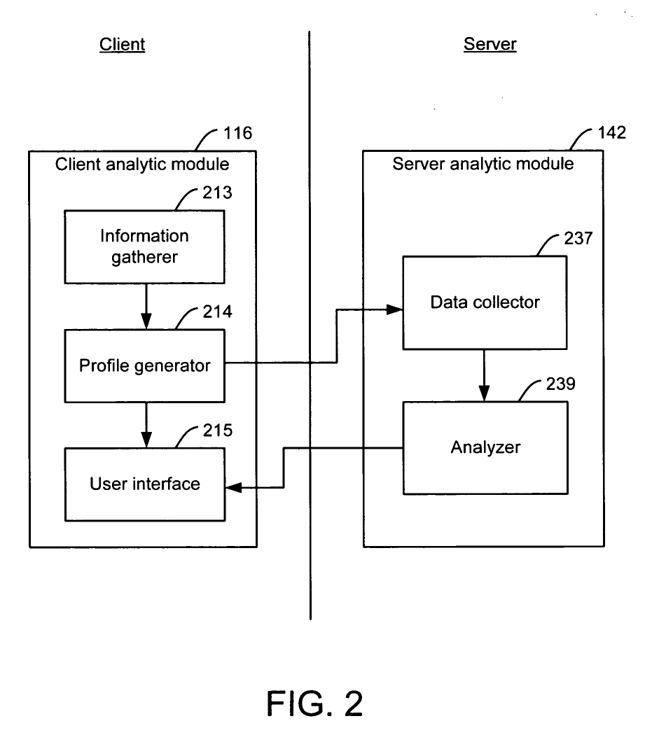

Client analytic module 116 may be configured to access certain client data 120 that is restricted and not accessible by other computing devices. Since the profiles generated by client data 120 typically contain characteristics of the client data 120, and not the data itself, client analytic module 116 may provide the profiles to server analytic module 142, without compromising the security and privacy of the restricted data. In this manner, client analytic module 116 is capable of generating profiles with information that is not available to other computing devices. To further enhance privacy and security, client analytic module 116 may also be configured to enable a user to set security preferences so that the user may specifically select the data that can be used to generate the user's profile. Example components of client analytic module 116 will be discussed in conjunction with FIG. 2.

Server 140 is a computing device associated with clients 105-106. Server 140 is associated with an organization to which clients 105-106 belong. For example, server 140 may be used by an administrator to manage the organization. As shown in FIG. 1, server 140 includes server analytic module 142 configured to monitor client 105-106. In particular, server analytic module 142 is configured to receive profiles corresponding to users that are associated with clients 105-106. For example, server analytic module 142 may receive a profile from client analytic module 116 corresponding to a user associated with client 105. Server analytic module 142 is configured to aggregate the profiles received from clients 105-106 and determine topics and relationships in the organization. Server analytic module 142 may be configured to provide the information about the communication and relationship trends to an administrator for making decisions regarding the organization. Example components of server analytic module 142 will be discussed in conjunction with FIG. 2.

System 100 is only an example embodiment of a distributed organizational analysis system. In actual implementation, a system with more, less, or different components may be used to perform similar functions. For example, in FIG. 1, client analytic module 116 is shown as an independent module. In another implementation, a part of or the whole client analytic module 116 may be integrated into communication tools 114 and productivity tools 115. In the figure, only example server analytic module 142 in server 140 is shown. Other implementations of the system may include multiple server analytic modules on multiple servers.

FIG. 2 shows example components of client analytic module 116 and server analytic module 142 illustrated in FIG. 1. As shown in FIG. 2, client analytic module 116 may include information gatherer 213, profile generator 214 and user-interface 215. Server analytic module 142 may include data collector 237 and analyzer 239.

Information gatherer 213 is configured to gather client data corresponding to one or more users associated with a client. The client data corresponding with each user gathered by information gatherer 213 is used to generate a profile associated with that user. As discussed above, the client data may include any type of communication data and local documents on the client. Information gatherer 213 may be configured to enable the user to specify which client data to gather for client analytic module 116. For example, information gatherer 213 may be configured to gather client data that is consistent with a security level specified by a user. Information gatherer 213 may also enable the user to specify the groups or types of client data that is available for gathering.

Profile generator 214 is configured to generate profiles for users associated with a client. In particular, profile generator 214 is configured to identify client data associated with a user and generate a profile for that user that may include data, such as the other users in an organization with which the user interacts, the keywords in communications associated with the user and in documents generated by the user, or the like. Profile generator 214 is configured to provide the profiles to server analytic module 142 for analysis. Profile generator 214 may be configured to provide the profiles in a specified time interval. Profile generator 214 may also be configured to make the profiles available to user interface 215 for viewing and management by users associated with the profiles. To enhance privacy, profile generator 214 may be configured to enable a user to restrict the types of data in the user's profile that is sent to server analytic module 142.

Data collector 237 is configured to receive profiles from clients in an organization. In particular, data collector 237 may receive the profiles from client analytic modules of the clients. Typically, each profile includes interaction patterns of a particular user and keywords in communications and local documents associated with the user. Data collector 237 is also configured to aggregate the profiles from the clients and provide data in the aggregated profiles to analyzer 239.

Analyzer 239 is configured to receive aggregated profiles from data collector 237 and to analyze the profiles to determine characteristics of an organization, such as relationships between users and groups in the organization and ideas that are discussed within the organization. For example, from the profiles, analyzer 239 may determine keywords that are used by the users within the organization, which may indicate topics that are popular within the organization. Analyzer 239 may compare the popularity of a keyword at different time intervals to determine whether a particular topic is gaining or losing popularity over time. Analyzer may also identify users associated with significant amount of communications and documents that contain a certain popular keyword. These users may be identified as experts within the organization on the topic that is indicated by the keyword.

Users with similar profiles, such as overlapping keywords, may be identified as potential corroboration partners. For example, if the overlapping keywords between two profiles exceed a threshold, the profiles may be considered as matching profiles. If the users associated with the two matching profiles do not have previous interaction, analyzer 239 may determine a third user that had previous interactions with both of the users associated with the two matching profiles. Analyzer 239 may provide contact information of the third user to one or both of the users associated with the two matching profiles.

Analyzer 239 may also be configured to analyze groups within the organization. For example, analyzer 239 may identify a group of users that include significant amount of communications with each other, which may indicate that the users are members of a community with certain characteristics. A community may also be indicated by users associated with substantial amount of communications and documents that include certain common keywords. As with the organization, analyzer 239 may track each group for keywords and experts. Analyzer 239 may also track the extent and the keywords in communications among the groups and the users between two groups who have significant communication with each other.

Analyzer 239 may further be configured to analyze individual user within the organization. For example, analyzer 239 may provide information about the group to which the user belongs and other social network information. Analyzer 239 may provide keywords and interaction trends of the user, the community and the organization to the user, such as through user interface 215. Analyzer 239 may also identify potential collaborative partners to the user based on analyzing matching profiles of users in the organizations. Analyzer 239 may also provide characteristics of other users, groups and the organization to a user that has proper access to the information, such as an administrator, a decision maker, or the like.

Analyzer 239 may also enable a user to create an agent that monitors particular characteristics of the organization and alerts the user when an event associated with the characteristics had occurred. For example, an agent may be created to alert the user of a particular emerging topic or a decline in interactions between certain groups. The agent may send an alert message to a client associated with the user.

As discussed above, a distributed organizational analysis system may perform a variety of functions related to determine interaction trends and discussion topics associated with an organization, and the communities and users within the organization. Below are examples of the functions that can be performed by a distributed organizational analyzer. The examples include personal analytics, community analytics and organizational analytics.

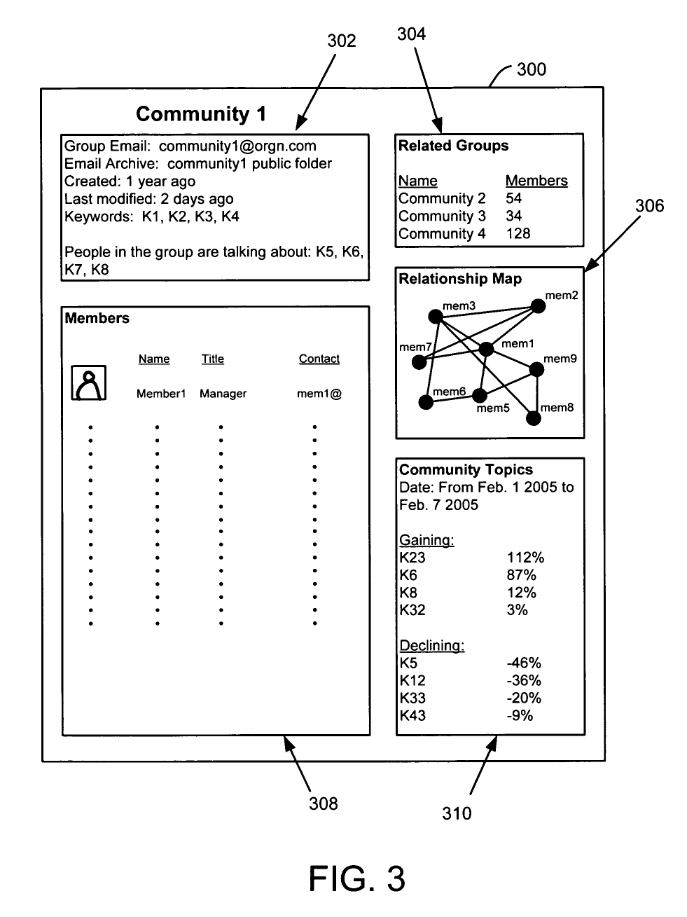

FIG. 3 shows a screenshot 300 of an example user interface for a distributed organizational analyzer. The example user interface may be used by the distributed organizational analyzer to present results to a user. The example user interface in FIG. 3 is configured to present information to a user associated with a group in an organization where the group is automatically determined by the distributed organizational analyzer based on analyzing profiles of users in the organization. As shown in the figure, the example user interface includes group information area 302 that contains information about the group. Membership area 308 includes a list of users belonging to the group and available information about the users. Related group area 304 includes information about other groups in the organization that are related to the current group. Relationship map area 306 includes a graphical depiction of the interactions between users in the group. Community topics area 310 shows the trends of popular topics that are discussed by users in the group.

The user interface in screenshot 300 is only an example shown for illustrative purposes. In actual implementation, more, less or different information may be included. Also, although the example user interface is configured to display information related to a group, other information may be displayed, such as information related to a user, the entire organization, or the like.

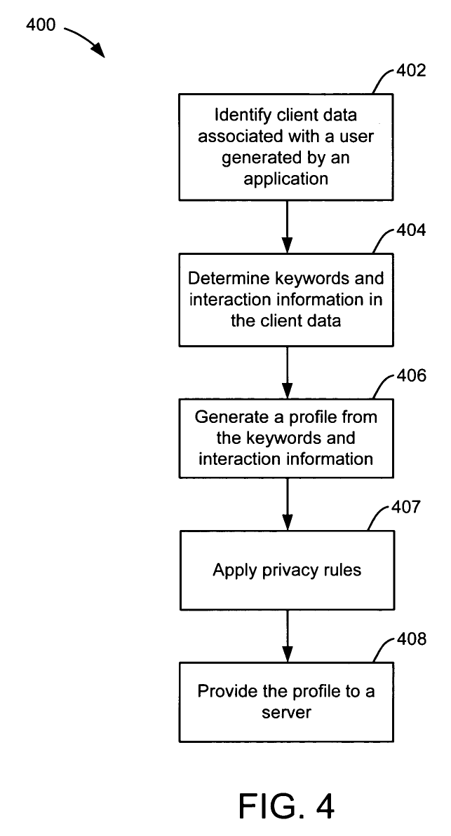

FIG. 4 shows an example process 400 for providing a profile associated with a user. Process 400 may be implemented by a client to provide profiles for users associated with an organization. At block 402, client data associated with a user is generated by an application in the client. The data may be restricted for privacy and security reasons. The application may include any device-executable component, such as an email application, messenger, or the like. At block 404, keywords and interaction information about entities in the organization with which the user had interacted are determined from the client data. To enhance privacy and security, the user may select which client data is available for this determination. At block 406, a profile associated with the user is generated from the keywords and the interaction information. At block 407, privacy rules are applied. The privacy rules may be applied to preserve the privacy of the data in the profile. For example, the rules may restrict the data in the profile in such a manner that would preserve the identity of the user. At block 408, the profile is provided to a server for analysis.

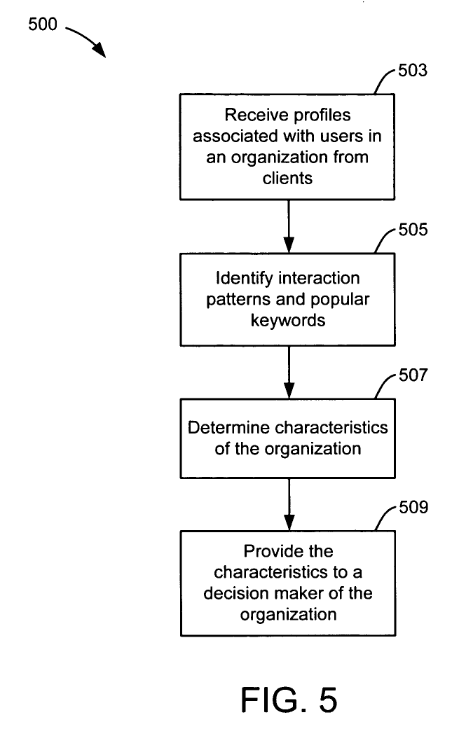

FIG. 5 shows an example process 500 for determining characteristics of an organization from profiles. Process 500 may be implemented by a server to determine characteristics of an organization from profiles received from clients associated with users in the organization. At block 502, profiles associated with users in an organization are received from the clients. At block 505, interaction patterns and popular keywords are identified from the profiles. At block 507, characteristics of the organization are determined from the interaction patterns and popular keywords. Since the characteristics of the organization are determined from profiles of the clients and not directly from client data, privacy of the users in the organization may be maintained. At block 509, the characteristics are provided to a decision maker associated with the organization.

Personal Analytics

Personal analytics provides a user with tools that enable the user to view her profile and social network on a dynamic basis. Personal analytics benefits users by helping them quickly identify their interests, both existing and emerging. Analytics also provide context around relationships by showing the emails, common keywords, common colleagues and related factors that connect people to one another.

In an example scenario, a user interface may be pre-populated with a number of critical user-related fields that immediately place the member in the context of her larger social and expertise network. The features of this scenario includes a list that shows the topics and colleagues that best describe a member's expertise and social network, respectively. A social network browser may be included to let the member quickly navigate her own first degree network, and view shared keywords and shared colleagues. This establishes a baseline set of relationships for each member that can be readily explored.

Lists may be used in personal analytics to show trends associated with a user. For example, a list of gaining keywords shows which topics are “hot” for that user. These “emerging” topics can serve as an early warning system for topics that are about to breakout (either positively or negatively). A list of declining keywords may show which topics are waning for that user. These “falling” topics can server as an indicator of declining priorities. A list of gaining colleagues may show which colleagues are increasing their interactions with that user. These “emerging” contacts may indicate the growth of an ad hoc (or formal) interest group. A list of declining colleagues may show which colleagues are reducing their frequency of interaction with that user. These “falling” colleagues may include people with whom the member does not want to lose contact and serve as a reminder to re-initiate communication with those people.

Personal analytics may be further enhanced by providing members with important trend-line information that is dynamically refreshed over time. These features may be implemented by taking a baseline measurement, followed by subsequent re-measurements that show the trend for a particular data set. A track queries feature may also be provided to track a user's queries and show top searches for the current week.

Personal analytics may show a list of profiles that match the member's profile and show which people in the network are most similar in terms of interests and/or colleagues. This forms the basis for collaboration opportunities. A list of recommended memberships, based on a matching of membership profiles, extends the member's reach into the larger network, providing her with collaboration opportunities she might otherwise have missed. Personal analytics can help identify emerging issues before they reach critical mass, thereby increasing awareness of emerging trends and saving time.

Community Analytics

Community analytics is configured to create latent connections to like-minded people for future use in problem-solving, networking and collaboration. Community analytics helps these communities identify the topics that matter most, and then enables them to quickly connect to community members who are most active around those topics, for the purposes of problem-solving and/or collaboration.

Community analytics may include a community keywords feature. Treating a community like a person, each community will have a profile consisting of keywords and colleagues (in the latter case, members). Community keywords section may be descriptive of top keywords associated with a community, as gained from analysis of email associated with that community.

Community analytics may also measure all keyword activity for all community members, regardless of whether it is related to that community or not. This serves as a measure of overarching issues of interest to community members.

Community analytics may include a People Search on a Keyword feature. This feature launches a people search and shows users which community members possess expertise around a particular topic. This speeds engagement and collaboration across the community.

Community analytics may include a social network browser. This feature allows users to browse their social network by navigating through names within their 1st Degree, 2nd Degree or 3rd Degree connections. This feature allows them to quickly see who is connected to whom within their overall network and browse to other colleagues at will. By default, the user may be at the center of the social network, but clicking on any node (person name) shifts the focus to that node. Community analytics may also include a track queries feature, which can be made through a community web part and show top searches for a time interval.

Community analytics may include a gaining keywords feature that treats the community like a “person,” measure its keyword activity (from month to month, week to week, etc.) as indicators of what the community is specifically talking about. Community analytics may also include a declining keywords feature that measures declining activity (month to month, week to week) as indicators of topics that are declining either because an issue has been resolved or because community members no longer care. Community analytics may further include a profile matching features that shows other users in the community who have similar profiles, based on percentage of overlap between (public) keywords. This analytic enables users to connect to other users who might make good collaboration partners.

Organizational Analytics

Organizational analytical is configured to use reports to help decision makers make decisions about their customers, partners and suppliers. They benefit from analytics that help them reach these decisions more quickly and accurately by identifying trends, collaboration patterns and emerging topics of interest to customers, partners and suppliers.

Organizational analytical may include a membership statistics feature. As an overall measure of penetration rates within an enterprise, show the percentage of employees who are also members of the distributed organizational analyzing system. Organizational analytical may also show a breakdown by community.

Organizational analytical may include a colleague interaction report that shows decision makers which people within two entities (AD groups, Share Point communities or an external entity) are communicating with each other.

Organizational analytical may include a keyword interaction report that shows decision makers what two entities (AD groups or an external entity) are talking about between them.

Organizational analytical may specify important topics (keywords or noun phrases) and track them independently of overall gaining/declining keywords. This may include the ability to set alerts on these topics, if activity rises above, or falls below, a user-determined level.

Organizational analytical may launch a people search and shows users which members possess expertise around a particular topic, which speeds engagement and collaboration across the enterprise.

Organizational analytical may include a gaining keywords feature that measures enterprise keyword activity (from month to month, week to week, etc.) as indicators of what the enterprise is specifically talking about.

Organizational analytical may also include a declining keywords feature that measures declining activity across the enterprise (month to month, week to week) as indicators of topics that are declining either because an issue has been resolved or because the enterprise is losing interest in this topic.

A distributed organizational analyzer discussed above may be configured to preserve privacy and security policies of an organization. Below are examples of rules that may be implemented to preserve privacy:

1. Gaining Keywords

If eight or more colleagues are talking about a topic (keyword or noun phrase), with at least four on the TO line and four on the FROM line, then public and private keywords can be displayed. This prevents inference attacks on the identity of the eight participants.

2. People Search on Gaining Keywords

People drilldown on Gaining Keywords must show ONLY those colleagues who have public keywords for the topic in question.

3. Declining Keywords

If eight or more colleagues are talking about a topic (keyword or noun phrase), with at least four on the TO line and four on the FROM line, then public and private keywords can be displayed. This prevents inference attacks on the identity of the eight participants.

4. People Search on Declining Keywords

People drilldown on Declining Keywords must show ONLY those colleagues who have public keywords for the topic in question.

5. People Are Also Talking About

If eight or more colleagues are talking about a topic (keyword or noun phrase), with at least four on the TO line and four on the FROM line, then public and private keywords can be displayed. This prevents inference attacks on the identity of the eight participants.

6. People Search on People Are Also Talking About

People drilldown on People Are Also Talking About must show ONLY those colleagues who have public keywords for the topic in question.

7. Keyword Interaction Report

If four or more colleagues are talking about a topic (keyword or noun phrase), then public keywords can be displayed, but private keywords must be suppressed. This prevents inference attacks on the identity of the four participants.

If eight or more colleagues are talking about a topic (keyword or noun phrase), with at least four on the TO line and four on the FROM line, then public and private keywords can be displayed. This prevents inference attacks on the identity of the eight participants.

8. People Search on Keyword Interaction Report

People drilldown on Keyword Interactions must have at least eight colleagues talking about that topic (four on the TO line and four on the FROM line) AND show only those colleagues who have public keywords for the topic in question.

9. Colleague Interaction Report

To show colleague interaction, both participants must have the other person listed in their public profile (public to public interactions only). Public to private and private to private interactions must not be displayed. Colleague interaction reports MUST NOT be linked to keywords or noun phrases.

The rules above are example rules for a particular organization and are included only for illustrative purposes. In actual implementation, similar rules may be used to achieve substantially the same privacy and security protection.

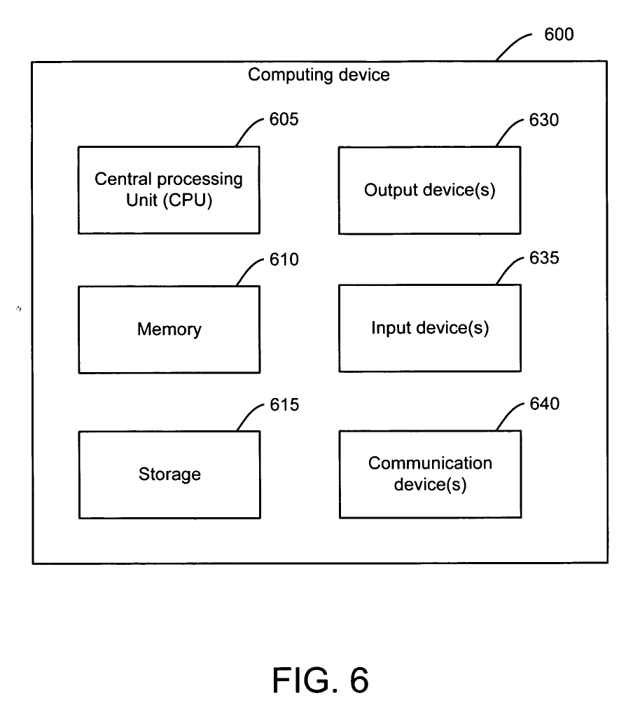

FIG. 6 shows an example computer device 600 for implementing the described systems and methods. In its most basic configuration, computing device 600 typically includes at least one central processing unit (CPU) 605 and memory 610.

Depending on the exact configuration and type of computing device, memory 610 may be volatile (such as RAM), non-volatile (such as ROM, flash memory, etc.) or some combination of the two. Additionally, computing device 600 may also have additional features/functionality. For example, computing device 600 may include multiple CPU's. The described methods may be executed in any manner by any processing unit in computing device 600. For example, the described process may be executed by both multiple CPU's in parallel.

Computing device 600 may also include additional storage (removable and/or non-removable) including, but not limited to, magnetic or optical disks or tape. Such additional storage is illustrated in FIG. 6 by storage 615. Computer storage media includes volatile and nonvolatile, removable and non-removable media implemented in any method or technology for storage of information such as computer readable instructions, data structures, program modules or other data. Memory 610 and storage 615 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 600. Any such computer storage media may be part of computing device 600.

Computing device 600 may also contain communications device(s) 640 that allow the device to communicate with other devices. Communications device(s) 640 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 600 may also have input device(s) 635 such as keyboard, mouse, pen, voice input device, touch input device, etc. Output device(s) 630 such as a display, speakers, printer, etc. may also be included. All these devices are well know in the art and need not be discussed at length.

While the preferred embodiment of the invention has been illustrated and described, it will be appreciated that various changes can be made therein without departing from the spirit and scope of the invention.

1. One or more device-readable media encoded with device-executable instructions for performing steps comprising:
receiving information provided by devices, the information provided by each device including a profile associated with at least one user belonging to an organization, the profile being automatically generated by the device based, at least in part, on analyzing client data associated with the at least one user;
identifying interaction patterns and popular keywords from the profiles provided by the devices; and
determining characteristics of the organization by analyzing the interaction patterns and the popular keywords.

2. The one or more device-readable media as recited in claim 1, wherein the characteristics of the organization includes at least one item from a group that comprises: relationships among users, popular topics, relationship trends, emerging topics, declining topics, groups within the organization, and collaborative patterns.

3. The one or more device-readable media as recited in claim 1, further comprising identifying groups in the organization based, at least in part, on the interaction patterns.

4. The one or more device-readable media as recited in claim 3, further comprising determining collaborative levels of the groups by analyzing interactions among the groups.

5. The one or more device-readable media as recited in claim 3, further comprising:
identifying common keywords in messages associated with users in at least one of the groups; and
determining popular discussion topics in the at least one group based, at least in part, on the identified common keywords.

6. The one or more device-readable media as recited in claim 1, further comprising:
identifying users in the organization having matching profiles; and
providing contact information to the identified users to encourage collaboration.

7. The one or more device-readable media as recited in claim 6, further comprising:
identifying overlapping keywords in the profiles associated with the users; and
if the overlapping keywords between two profiles exceed a threshold, determining the profiles as matching profiles.

8. The one or more device-readable media as recited in claim 7, further comprising:
if the users associated with the two matching profiles do not have previous interaction,
determining a third user that had previous interactions with both of the users associated with the two matching profiles; and
providing contact information of the third user to at least one of the users associated with the two matching profiles.

9. The one or more device-readable media as recited in claim 1, further comprising providing at least one of the determined characteristics to at least one of the users in the organization.

10. The one or more device-readable media as recited in claim 1, further comprising:
creating an agent configured to monitor at least one of the characteristics;
determining an event associated with the at least one characteristic; and
notifying a user associated with the agent of the event.

11. The one or more device-readable media as recited in claim 1, wherein the client data in each profile includes at least one item from a group that comprises: identities of entities with which the user associated with the profile had communicated, keywords in communications sent by the user, and privacy preferences.

12. A system for analyzing data related to an organization, the system comprising:
multiple client devices each configured with at least one communication tool, each client device including a client analytic module configured to generate a profile associated with at least one user belonging to the organization, the profile including keywords in client data associated with the user and processed by the communication tool, the profile also identifying entities with which the user had interacted; and
a server device including a server analytic module configured to receive profiles from the client devices, the server analytic module also configured to identify from the profiles keywords that are most frequently included in the client data associated with the users in the organization, the server analytic module also configured to determine topics that are popular in the organization.

13. The system as recited in claim 12, wherein the server device is further configured to identify the keywords from different time intervals to determine topics that are changing in importance over time in the organization.

14. The system as recited in claim 12, wherein the server analytic module also configured to determine interaction patterns among the users in the organization based, at least in part, on the received profiles, the server analytic module further configured to determine relationships trends between users in the organization.

15. The system as recited in claim 12, wherein the server analytic module also configured to determine interaction patterns among groups in the organization based, at least in part, on the received profiles, the server analytic module further configured to determine relationships trends between groups in the organization.

16. The system as recited in claim 12, wherein the communication tool includes at least one item from the group that comprises: an email application, a messenger, a weblog application, a newsgroup application, and a web browser.

17. The system as recited in claim 12, wherein at least one of the client devices includes a client analytic module that is configured to enable a selection of a security preference operable to control which client data is used by the client analytic module to generate a profile.

18. A system with clients and at least one server, each client associated with at least one user in an organization, the system comprising:
means for the clients to monitor communication data associated with users;
means for the clients to generate profiles associated with users in the organization from the monitored communication data;
means for the clients to provide the profiles to the server through a network;
means for the server to determine popular topics and relationship trends from the profiles provided by the clients; and
means for providing the popular topics and relationship trends to at least one of the users in the organization.

19. The system as recited in claim 18, further comprising means for creating an agent that monitors at least one of the popular topics and relationship trends.

20. The system as recited in claim 18, further comprising means for the server to determine at least one item in the group comprises: emerging topics, declining topics, experts on a topic, collaboration partners, and social networks.
